(19) United States
(12) Patent Application Publication
(10) Pub. No.: US 2003/0121054 A1
(43) Pub. Date: Jun. 26, 2003

(54) Display for a client terminal for an interactive video casting system

(75) Inventor: Kim E. Lorenz, Bellevue, WA (US)

Correspondence Address: SEED INTELLECTUAL PROPERTY LAW GROUP PLLC, 701 FIFTH AVENUE, SUITE 6300, SEATTLE, WA, 98104-7092, US

(73) Assignee: digeo, inc., Kirkland, WA (US)

(21) Appl. No.: 10/033,365

(22) Filed: Dec. 26, 2001

(51) Int. Cl. H04N 7/025; H04N 7/10; H04N 7/173; H04N 7/16

(52) U.S. Cl. 725/112; 725/109; 725/136

(57) ABSTRACT

A system and method to provide a display for a client terminal for a television communicatively coupled to an interactive video casting network are provided. The display can present indicia related to events available through the client terminal. Operational features of a client terminal can also be displayed. User preferences can play a role in the appearance and/or content of the displayed indicia. Indicia can appear in the form of text, graphics, or sound and be related to any events such as, but not limited to, news headlines, e-mail and voicemail announcements, miscellaneous reminders, program alerts, and emergency alerts. With the use of the display, information may be displayed therein at least alternatively to being displayed on a screen of the television, thereby reducing crowding on the screen of the television.

### TECHNICAL FIELD

This disclosure relates generally to display devices, and more particularly but not exclusively, to a display for a client terminal for an interactive video casting network.

### BACKGROUND

Advances in technology have provided viewers with access to numerous sources of information and entertainment. The Internet, e-mail, and cable and satellite television are a few illustrations of convenient and effective methods of information dissemination available today. Moreover, recent developments in technology include accessible, yet non-intrusive, methods to convey information to the consumer. For example, some audio playback devices can display artist and song information as a music track is played; many kiosks in office buildings and shopping malls can provide Internet access and also scroll the latest news headlines or stock prices across the screen. The displays on such equipment often use cathode ray tube (CRT), light emitting diode (LED), or liquid crystal display (LCD) technology, for instance.

Viewers usually welcome additional information, although in some cases, a television screen may become overly crowded with images and/or text. For example, many television channels, such as CNN Headline News™, present additional information (e.g., news headlines) during programming along the bottom of a picture. Unfortunately, the text can sometimes occupy up to one third of the screen. Another example includes the closed captions feature offered by many television programs and commercials. Such captions can be useful in noisy environments and/or for the hearing impaired, but can also result in a significant portion of the screen being overlaid with text.

In contrast, many pieces of home electronics equipment do not have a problem with crowding of images and text, but also do not have the advantage of conveying useful information to a viewer. When a piece of equipment is turned on, most displays only show a function that is activated, for example, a videocassette recorder (VCR) display might show “rewind” or “play” when those functions are turned on. When the equipment is not being used, such a display usually shows the time of day. As a result, VCRs, digital video disk (DVD) players, stereo receivers, and cable set top boxes, often kept in the same vicinity, may all flash the time redundantly.

Technology has created a high demand for access to information with minimal time, effort, and intrusion. As a result, additional information can be displayed on television and other electronic devices. Unfortunately, disadvantages may also exist, such as excessive crowding of text and images on a single screen. In addition, many of the displays on electronics equipment do not produce any significant benefit. Accordingly, improvements are needed in the area of providing information to consumers via electronic equipment accessible in their own homes.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 shows an example of an interactive television system that can implement an embodiment of the invention.

FIG. 2 is a block diagram of an example client terminal with a display for the interactive video casting system of FIG. 1 that can implement an embodiment of the invention.

FIGS. 3-11 illustrate example uses of embodiments of a display for the client terminal for the interactive video casting system of FIGS. 1 and 2.

FIG. 12 is a flow diagram illustrating operation of an embodiment of the invention.

### DETAILED DESCRIPTION OF THE ILLUSTRATED EMBODIMENTS

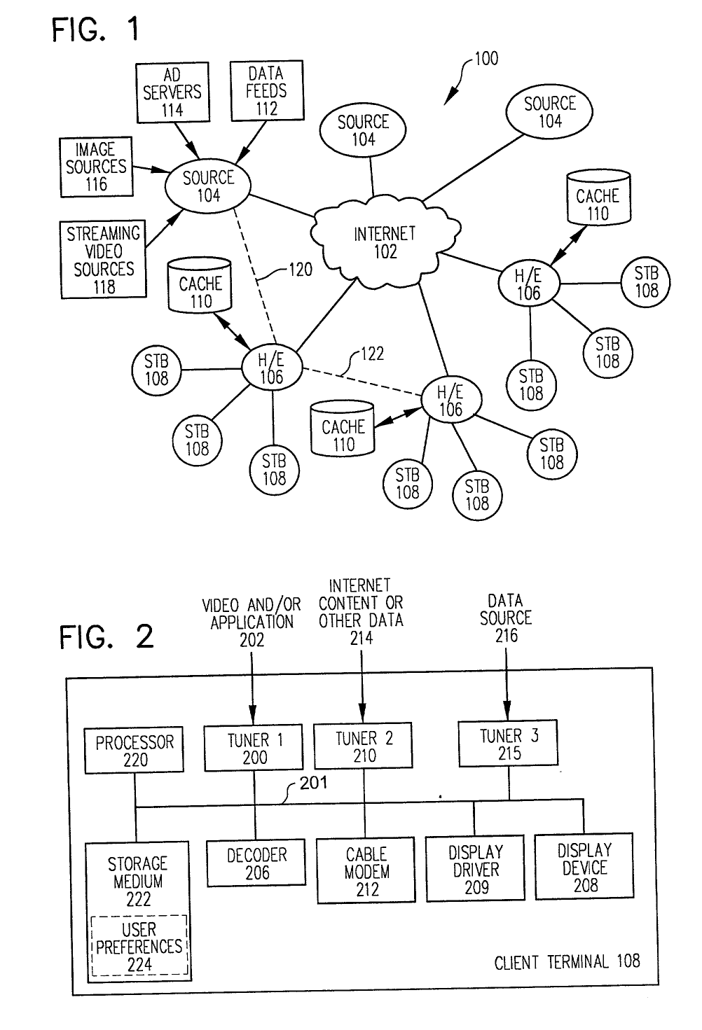

Embodiments of a system and method for a display for a client terminal are described herein. In the following description, numerous specific details are provided, such as in the interactive video casting system of FIG. 1, to provide a thorough understanding of embodiments of the invention. One skilled in the relevant art will recognize, however, that the invention can be practiced without one or more of the specific details, or with other methods, components, materials, and the like. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, an embodiment of the invention can provide a display for a client terminal that presents information on a variety of subjects, including but not limited to, news, messages, reminders, announcements, e-commerce opportunities, or other events. Text, graphics, and sound can be a part of a client terminal user interface. Light emitting diode (LED), liquid crystal display (LCD), gas plasma, or any other type of suitable display technology can be used.

FIG. 1 shows an example of an interactive video casting system 100 for distributing interactive content in addition to television content. The interactive video casting system 100 can comprise an interactive television system, as one example of a system that can implement an embodiment of the invention to provide messages via the display for a client terminal.

In accordance with an embodiment of the present invention, the system 100 can be integrated with a cable television distribution system. The system 100 includes an Internet 102, a plurality of content sources 104, a plurality of distribution centers or broadcast centers (depicted as head-ends or H/Es 106), and a plurality of client terminals 108 (depicted as STBs). In addition, a content source 104 is depicted as receiving data from data feeds 112, advertisement servers 114, image sources 116, and streaming video sources 118. The plurality of content sources 104 is coupled to the Internet 102. For example, a content source 104 may comprise a web site portal such as Go2Net.com™, or a news web site such as CNN.com™, or other types of sources, including web servers and the web content (such as web pages) stored in the web servers. Each content source 104 may have various data feeds 112, servers 114, and sources 116/118 coupled to it.

For example, news or stock quote feeds 112 may be fed into the content source 104. Servers 114 may provide advertisements for insertion into multimedia content delivered by the content source 104. Sources 116/118 may provide images 116, streaming video 118, and other content to the content source 104. Various other feeds, servers and sources may also be coupled to the content source 104 of FIG. 1.

The Internet 102 comprises a network of networks and is well known in the art. Communications over the Internet 102 can be accomplished using standard protocols such as transmission control protocol/internet protocol (TCP/IP), hypertext transfer protocol (HTTP), file transfer protocol (FTP), or other protocols. The Internet 102 is coupled to the plurality of distribution centers 106, and each distribution center 106 is in turn coupled to a plurality of client terminals 108, which may comprise a set top box, a PC, an interactive television set, or another type of communication device or display device. The client terminals 108 may include or be coupled to a machine-readable medium that stores software or other machine-readable instructions to drive a display for the client terminal 108 as will be described later below.

In alternative or in addition to the Internet 102 being used to distribute multimedia content from the content sources 104 to distribution centers 106, communications channels or networks 120 apart from the Internet 102 may couple one or more content sources 104 to one or more distribution centers 106. A first dashed line 120 in FIG. 1 illustrates one example of such an alternate path for communications. Alternately or additionally, peering connections may exist between distribution centers 106. A second dashed line 122 in FIG. 1 illustrates one example of such peering. Other configurations are also possible and are included within the scope of the present invention.

Caches 110 may be provided at (or coupled to) the distribution centers 106. Such caches 110 may be used to increase the performance in the delivery of multimedia content to the client terminals 108. For example, larger files for video and other high bandwidth content may be stored in such caches 110, which may be closer to the client terminals 108 than to the content sources 104. In addition, reliability and guaranteed bandwidth may be provided because the Internet 102 is not in-between such caches 110 and the client terminals 108.

In an embodiment, servers may be present in the distribution centers 106, with such servers including or otherwise coupled to the caches 110. Alternatively or in addition, these servers may be located remotely from but still communicatively coupled to the distribution centers 106, such as in the Internet 102. According to various embodiments, some of these servers may provide data, such as via a Data Over Cable Service Interface Specifications (DOCSIS) channel, or other data via other communications paths to the client terminals 108.

FIG. 2 is a block diagram of an embodiment of a client terminal 108 for the system 100 of FIG. 1 that can implement an embodiment of the invention. For the sake of simplicity of illustration and explanation, only the components that are germane to understanding an embodiment of the invention are shown in FIG. 2. It is understood that the embodiment of the client terminal 108 shown in FIG. 2 can have other components. Moreover, the various illustrated components may be suitably combined in some embodiments, instead of being separate. A bus 201 is shown symbolically to depict coupling between the various components.

The client terminal 108 comprises a first tuner 200 to tune to a television signal, Moving Pictures Experts Group (MPEG) stream 202, or other video source. The stream 202 may include video, live transmission, and/or application code, including corresponding text and graphic resources. One skilled in the art will recognize that there will be a plurality of streams 202, depending on the number of channels and programs that the cable service provider makes available to the client terminal 108.

The first tuner 200 is coupled to a decoder 206 that decodes the video, applications, and/or audio into a format that is compatible with a television set coupled to the client terminal 108. The client terminal 108 may include a second tuner 210. The second tuner 210 can work in conjunction with a cable modem 212 to obtain content from the Internet 102, such as via a DOCSIS channel. More specifically, in an embodiment of the invention, the second tuner 210 and the cable modem 212 can obtain Internet content or other data via a second source 214, including but not limited to, news headlines, announcements, offers, e-mail alerts, and stock market updates sent from the Internet 102, messages from a multiple system operator (MSO), and so on. It is to be appreciated that some of this data may arrive by way of the first tuner 200, such as via triggers for instance, additionally or alternatively to the second tuner 210.

An embodiment of the client terminal 108 may include a processor 220 to control operation of the various components shown in FIG. 2. The processor 220 may work in conjunction with software or other machine-readable instructions stored on a machine-readable storage medium 222. Such software may cooperate with the processor 220 to modify or process the content and/or appearance of data for display, to control the tuners to tune to a data source, select and retrieve data to display, and so on.

In addition, the client terminal 108 includes or is coupled to a third tuner or other input component 215. In an embodiment, the third tuner 215 can be an out-of-band-tuner capable to receive miscellaneous data for eventual display on the display for a client terminal. As an example, the tuner 215 can receive data that can also be received from a DOCSIS channel (e.g., stock ticker information, program announcements, and the like). Other examples of data capable to be received can include messages from an MSO, such as communications relevant to the viewer's account. In some embodiments, instead of or in addition to this third tuner, the input component 215 can comprise a network interface or other communication interface. Examples include a telephone interface to a voicemail system; an interface to a personal computer, audio system (e.g., CD players, home entertainment system, and the like), video recorder/player device, and so forth.

The client terminal 108 also may be coupled to or contain a display device 208, which can appear on a portion of a front panel or cover an entire front panel of the client terminal 108, as will be discussed in reference to an embodiment shown in FIG. 12. A detachable display device is also contemplated. As noted previously, the display device 208 can be of any suitable display type, such as, but not limited to, backlit displays, 7-segment displays, 4-digit displays, color thin-film transistor (TFT) LCDs, gas plasma displays, cathode ray tube, as among the various possibilities. In an embodiment, graphics as well as text can be displayed and single and/or multiple lines of text can be presented. Coupled to the display device 208 is a display driver 209, containing a collection of codes or other software for controlling the display device 208. As an example, the display driver 209 can translate a command from the processor 220 to present indicia to be displayed by the display device 208, to change a display mode of the display device 208, to change the indicia being displayed, and so forth.

In an embodiment of the invention, a storage medium 222 can store user preferences 224, alternatively or in addition to having such data stored at the cache(s) 110, at the cable head-end 106 or any other suitable location. User preferences can include data related to categories of events conveyed by the indicia, as well as a format of the indicia, including an appearance, timing, and/or sequence of such indicia. The client terminal 108 can receive events transmitted from the cable head-end 106, which gets its information from content source 104 or the Internet 102.

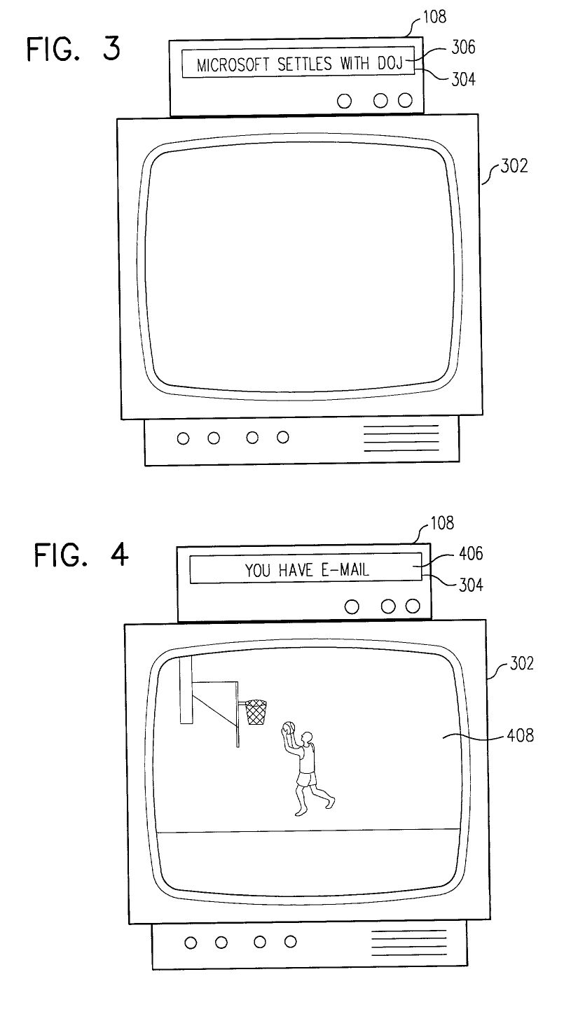

FIGS. 3-11 illustrate example uses of an embodiment of a display 304 for a client terminal 108, with the display 304 comprising the display device 208 and the display driver 209 in this example. In FIG. 3, the client terminal 108, including the display 304 rests upon a television set 302, which can be turned on or off. In an embodiment, an event comprises information, announcements, and messages about various subjects of interest to a viewer that can be displayed via the display 304. In this example, the event includes a breaking news event, “Microsoft settles with D.O.J.” 306 displayed for the viewer. Examples of other events can comprise sports scores, a stock market “ticker”, entertainment and science news, local weather, travel, and the like. In an embodiment, the client terminal 108 can receive preferences related to the events conveyed by indicia. For example, the viewer can limit or specify displayed indicia to indicia related to a particular category of event, such as, in this case, breaking news events. Or a viewer may choose to view a combination of several categories of events, such as breaking news as well as sports scores. The viewer may also specify other preferences, such as frequency of notification, length of time to display indicia, and so on. Such preferences can be stored as user preferences 224 in the storage medium 222 of the client terminal 108.

In this instance, the breaking news event can arrive at the client terminal 108 by a variety of mechanisms. For instance, an Advanced Television Enhancement Forum (ATVEF) trigger can be inserted into a vertical blanking interval (VBI) of a television signal by local studios, broadcast centers (such as at the head-end 106), or other content providers. Note that other standards that may be used to provide triggers include triggering mechanisms from Wink™ and Worldgate™. In an embodiment, a uniform resource locator (URL) address of a web page can be included as the trigger embedded in the television signal received via the first tuner 200. The processor 220 may then use software in the storage medium 222 to detect and analyze the URL, and can cause the second tuner 210 to receive, by way of tuning via the DOCSIS channel, specific content contained within the web page pointed to by the URL. For example, events such as specific headlines from CNN.com™, rather than an entire web page, can be extracted in an embodiment, although it is to be appreciated that in other embodiments, the web page may be “read,” its content converted to text, and then the text is displayed on the display 304.

In other embodiments, the client terminal 108 does not need to connect to the Internet to receive data. Information about the event itself can be included as the trigger embedded in the television signal received by the first tuner 200 or as a trigger or other information received in the out-of-band data stream tuned to by the third tuner 215. Ultimately, once the client terminal 108 receives the event, whether via the first, second or third tuners (or combination thereof), the event can be stored in the storage medium 222 where it may be accessed by the processor 220. The processor 220 then can analyze the stored information in conjunction with user preferences 224 to determine whether the event should be processed into indicia to be presented on the display 304. The processor 220 may also format the data and/or cause an addition of an audio component and ultimately send the data to the display driver 208 and/or audio output component for eventual presentation.

In addition to the indicia of events discussed above (e.g., information, announcements, and messages about various subjects of interest to the viewer), the display 304 can also present indicia representing the time, channel, program information, menu selections, and other functional operations related to the client terminal 108 in an embodiment. For example, indicia related to viewer menu selections can be displayed upon user input related to a function, such as, “VCR”, “DVD”, “Help Index”, and the like. Indicia related to program information may include content such as information related to a DVD the viewer is watching (e.g., a disk title, producer name, additional time left on the track, and so on). Such information may be provided to the client terminal 108 by way of the input component 215 in one embodiment, and eventually displayed on the display 304 without having to be necessarily displayed on the television set 302, thereby reducing the crowding/distraction of information on the television set 302.

FIG. 4 illustrates that in an embodiment, an event such as an alert related to a message for the viewer, can be presented as indicia. Alerts can be received that are related to e-mail, voicemail, incoming phone calls, or other message systems utilized by the viewer. In this example, the television set 302 displays regular programming, in this case, a basketball game 408. At the same time, the display 304 can present indicia, “You Have E-mail” 406 indicating that a new message has arrived at the viewer's e-mail account. Preferences by a viewer regarding an amount or type of information displayed can also be implemented. For example, the indicia 406 can include a display of header information related to the e-mail message, such as subject, sender, time sent, and the like.

In a related embodiment, indicia representing an instant message (IM) received by the viewer can also be displayed. Instant messaging involves the ability to see if a particular friend or coworker is connected to the Internet, and if so, to exchange messages with them. An example of instant messaging includes the popular AOL Instant Messenger™. Thus, in an embodiment, an IM, as well as any response entered by the user, can appear as indicia on the display 304. As a result, the viewer can continue to watch television programming while having a real-time online exchange displayed on the client terminal 108, instead of on the television set 302.

In an embodiment, when new mail or an IM is received through an Internet service (e.g. America Online™, CompuServe™, and the like), notification may be received from the Internet via the second tuner 210, on a DOCSIS channel. As an alternative, a TCP/IP communication, received through an Ethernet port connected through a digital subscriber line (DSL) connection or a dial-up modem, can be used to connect the client terminal 108 to the Internet. Upon viewing the indicia 406, the viewer can tune to an appropriate channel to open an e-mail application, or if the viewer wants to send an IM, a response can be sent, via a user input device in communication with the client terminal 108, to the Internet on the DOCSIS channel or other TCP/IP communication. Events including voicemail alerts, incoming phone call alerts, and other related phone-messaging alerts can be received via a phone connection or other network connection that link the viewer's phone service provider to the client terminal 108, thereby allowing the display 304 to display such alerts in an embodiment.

In an embodiment, another type of alert event that can be relayed via the client terminal 108 includes an emergency alert tone. Additionally, information related to an emergency situation, such as information that usually follows such a tone, can also be received and presented as indicia on the display 304. Examples of emergencies associated with a tone may include announcements related to potential disaster situations, including weather, hazardous materials spills, terrorism and the like. Emergency tones are sent out on specific emergency channels and some MSOs may have a responsibility for relaying a specific emergency alert signal to client terminals. Thus, in an embodiment, the tuner 215 may receive, via an out-of-band data stream, an emergency alert tone and/or additional information from an MSO or emergency alert service. After being received and stored in the storage medium 222 (if appropriate), the processor 220 can detect and analyze the alert event as an emergency alert, format the data accordingly (e.g., more prominent indicia than usual), add data related to sound if necessary, and cause a command to be sent to the display driver 209 and/or audio output component regarding the presentation of the indicia. Note that the client terminal 108 can have speakers for use when the television set 302 is not being used, in some implementations.

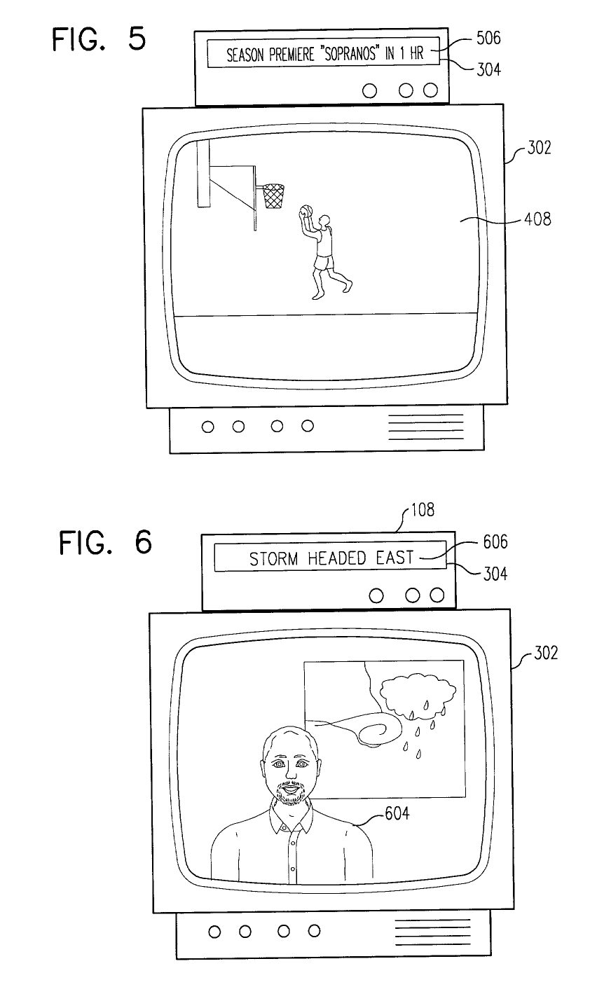

FIG. 5 illustrates an embodiment of the invention wherein an event related to program information can be received, resulting in display of indicia on the client terminal 108 rather than on a television screen. Indicia can correspond to future actions that are to be taken in regard to programs, such as for example, but not limited to, reminders to tune-in to or to record a program, to schedule an unattended recording of a program, to provide information about the program itself (e.g., whether the program is special programming, a movie, or part of a series), and so on. For example, in FIG. 5, the display 304 can present indicia “Season Premiere ‘Sopranos’ in 1 Hr” 506, reminding the viewer of an upcoming program, while the viewer watches the basketball game 408. Indicia can be displayed up to a week in advance and/or up to shortly before a particular program begins, or other suitable time. In an embodiment, user preferences may be received that are related to types of program information and/or announcements the viewer would like to receive. For example, some viewers may only want indicia of announcements related to children's programs to be displayed, while others may only want indicia of sports programs displayed. These preferences can be stored in user preferences 224 in the client terminal 108, at the server at the head-end 106, or any other suitable location.

The client terminal 108 can receive events such as program information in a variety of ways. In one embodiment, the third tuner 215 can receive program guide data from an MSO or other cable provider via an out-of-band data stream. The program information can subsequently be stored in the storage medium 222, from which the processor 220, may access the data to convert the program information into indicia that is appropriate for display. In doing so, the processor 220 can take user preferences 224 (or other user preference data sent from another storage area) into account, to determine which program information should be displayed as indicia. Program guide data and other information can also be received from a server located at the cable head-end 106 and/or the Internet, in an embodiment. Thus, the second tuner 210 may receive the data on a DOCSIS channel and the processor 220 can then proceed as described above. In yet another embodiment, program information may be embedded in a television signal received by the first tuner 200, such as via triggers, for instance. The triggers may be inserted by local studios, broadcast centers (such as the head-end 106), or other content providers.

Additionally, in an embodiment, closed captions can be shown as indicia on the display 304 as an alternative to being displayed on a television screen. In FIG. 6, a newscaster 604 may report news while closed captions sent with a television signal are presented as indicia “Storm headed east” 606 on the display 304. Thus, instead of having captions overlay the screen and interfere with television images, the display 304 can present the captions. Closed captions may be embedded in a VBI of a television signal and thus can be received by the first tuner 200. In an embodiment, the decoder 206 can decode the data into a format that is compatible with the client terminal 108 and then the data can be stored (e.g., cached) in the storage medium 222 as necessary. The processor 222 may then process the data and cause the data to be sent to the display driver 209 for eventual display on the display 304. In a related embodiment, the display 304 can also show indicia of captions and/or subtitles encoded on DVDs or other media.

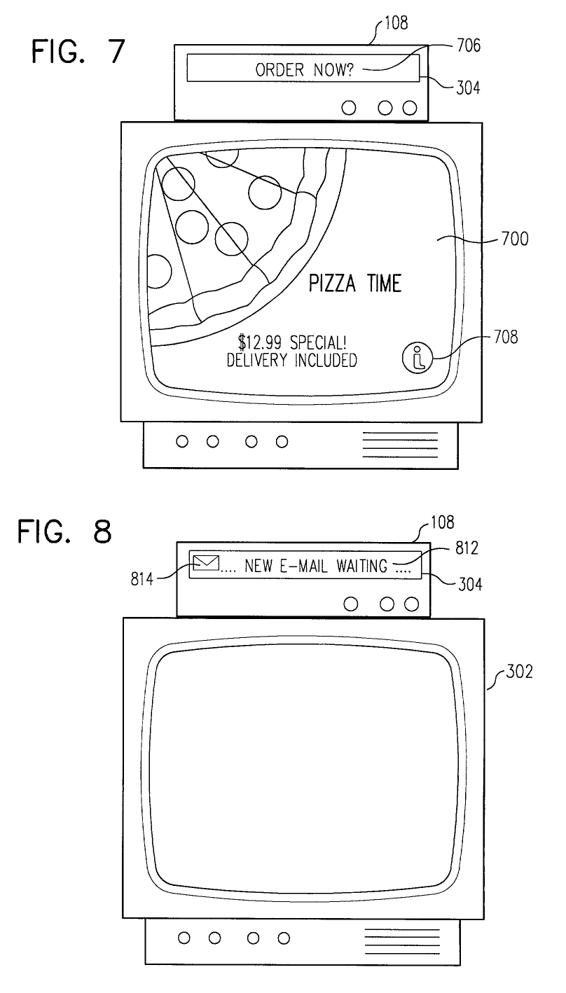

FIG. 7 illustrates that, in an embodiment, the indicia on the display 304 can provide information about an event such as interactive services and/or e-commerce opportunities that a cable service provides. For example, in FIG. 7, a pizza commercial 700 presents a pizza delivery service. If a viewer “clicks” on an “i” icon 708 in a lower right area of a screen, a transaction opportunity can be initiated relating to services offered by the commercial 700. In an embodiment of the invention, the transaction opportunity may also be presented to the viewer via “Order now?” indicia 706 on the display 304. In some cases, indicia can replace text or symbols that would otherwise be displayed on the television screen. In other cases, as in FIG. 7, the indicia may supplement interactive icons already displayed on the screen. Such a feature may be particularly useful for viewers who may not be familiar with an interactive television service and do not recognize a displayed symbol, such as the icon 708. It should be noted that interactive services can be related to purchase transactions but they can also be requests for information, or any other type of related opportunity. In an embodiment, the client terminal 108 can receive an affirmative response from the viewer through a user input device and present the viewer with an appropriate channel through which to complete the transaction.

Note that triggers, such as the ATVEF triggers discussed in relation to previous figures, can be used in this situation. For instance, an ATVEF trigger containing a URL address can be inserted into a VBI of a television signal by local studios, broadcast centers (such as the head-end 106), or other content providers. The television signal containing the trigger can be received via the first tuner 200. Information may be included related to an expiration of the event (e.g., instructions that displayed indicia related to the event terminate after a set period, in this case, at the end of the commercial 700). In an embodiment, if an indication of a positive viewer response to the inquiry such as “Order Now?” is received by the client terminal 108 via a user input device, the processor 220 may cause the second tuner 210 to receive a web page (or pages) via the DOCSIS channel through which the viewer can complete the transaction. The web page can be displayed in place of the television signal or in addition to the signal.

FIG. 8 illustrates that, in an embodiment, indicia can take a form of text, such as, “New E-Mail Waiting” 812, or a graphical image, such as an envelope icon 814 (also representing a new e-mail message) located in a corner of the display 304. In an embodiment, a viewer can indicate format preferences related to whether the indicia are text and/or graphics as well as preferences related to a size, appearance, and/or animation of the indicia. For example, indicia may be static and/or scrolling, as illustrated by the icon 814, which remains motionless while the indicia, “New E-mail Waiting” 812 scrolls across the display 304. In addition to scrolling text and/or graphics, additional animation and/or sounds may also be included in the presentation of indicia. In an embodiment, preferences related to a format of indicia can be received by the client terminal 108 from a user input device and stored in user preferences 224 of the storage medium 222. The user input device can, as before, comprise a remote control, wireless keypad, and the like. Thus, the processor may use data related to the user preferences in conjunction with an event, also stored in the storage medium 222, to generate indicia that is customized by the viewer for display or presentation.

FIG. 9 illustrates that, in an embodiment, indicia related to different categories of events can be displayed sequentially. In this instance, the viewer has chosen to receive indicia of sports news alternately with indicia of e-mail alerts. In FIG. 9, indicia “Huskies Win” 1002, may scroll by, followed by indicia “New E-mail Waiting” 912. In an alternative embodiment, where indicia are not scrolling, sports news indicia can flash alternately with the e-mail indicia on the display 304. Note that a viewer preference for any combination or sequence of represented events can be implemented. The viewer can also select a duration of displayed indicia; for example, indicia of sports news may flash for 20 seconds, and indicia of e-mail alerts for 10 seconds. Note that a channel number, time, or any other functional display can be displayed in sequence with the indicia of events. In an embodiment, the display 304 continues to display indicia of functional operations (e.g., a channel number, menu functions, and the like), but the indicia disappear once no longer needed. For example, the channel number may be displayed immediately after a channel is changed, but then only periodically thereafter.

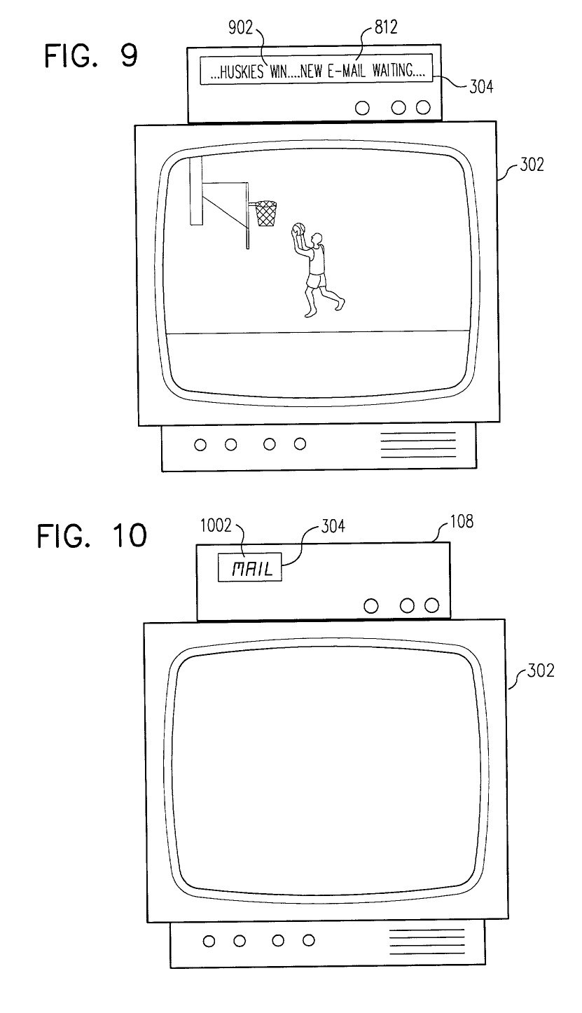

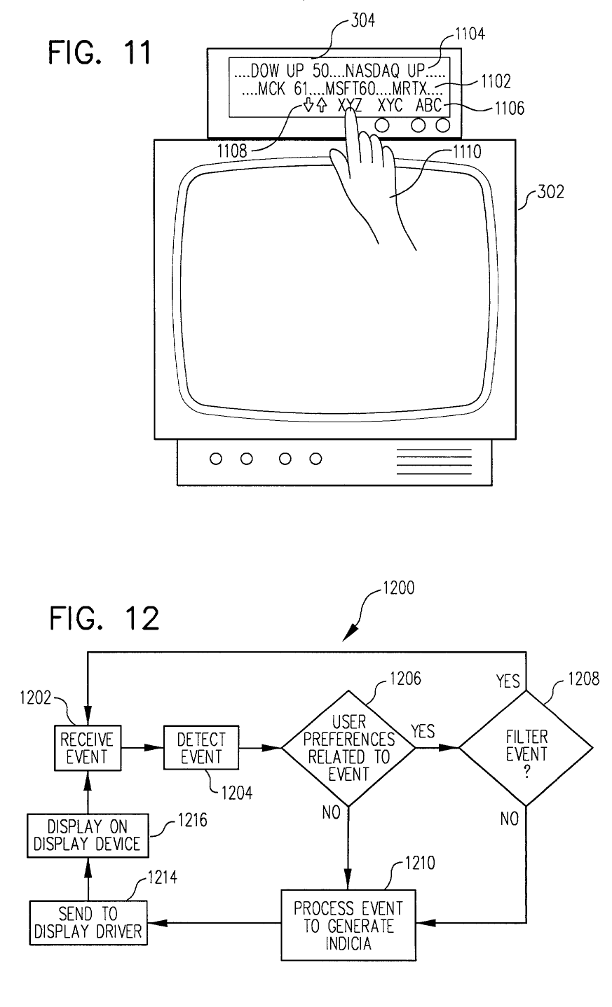

FIGS. 10 and 11 illustrate that different embodiments of a screen on the display 304 may be possible. FIG. 10 shows the display 304 as a four-digit display presenting an indicia “MAIL” 1002. In other embodiments, displayed indicia can include messages such as, “NEWS” (“news”), “ALRT” (“alert”), MSSG (“message”), and the like. In another embodiment, the display 304 can be a seven-segment display. Note that sequencing of indicia can also be implemented according to viewer preferences, similar to the example discussed in relation to the last figure. For example, indicia of the time and channel can be displayed alternately with “MAIL” 308 or other indicia.

FIG. 11 illustrates that the display 304 can comprise substantially an entire front of the client terminal 108 in an embodiment. In FIG. 11, the display 304 displays a stock ticker 1102 and above it, finance-related news 1104. This illustrates an embodiment where the display 304 can present multiple lines of text. In this instance, the client terminal 108 has no “hard” buttons or dials on the front panel. Instead, the display 304 comprises a touch screen, including “soft” buttons 1106, that can appear as text and/or graphics. Such “soft” buttons 1106 can be activated by a touch of a finger 1110 to control available options, or wirelessly via response to a remote control. For example, arrows 1108 can indicate soft buttons that can correspond to the television set 302 or the display 304 settings, such as, but not limited to, volume, contrast, size of text, and the like. Note that in other embodiments, the display 304 can display multiple lines of indicia without comprising the entire front of the client terminal 108.

In an embodiment, the display 304 can also be detachable. For example, the entire front of the display 304 may be capable of being removed from the client terminal 108. Links between the display 304 and the client terminal 108 can be wireless or by a cable connection. The display can be moved by a viewer to a kitchen or other areas of a home or office to continue to receive indicia such as stock quotes, news headlines, e-mail alerts, and the like, for instance. In a related embodiment, the display 304 may be detachable as part of a hand-held remote control.

FIG. 12 is a flow diagram illustrating an example sequence of events associated with an embodiment of the invention. Algorithms represented by portions of the flow diagram 1200 may be implemented by software, software modules, or other machine-readable instructions stored on one or more machine-readable storage media. The machine-readable storage medium may be located in a server, the caches 110, in the client terminal 108, or at other suitable locations (or combination thereof) in the interactive video casting system 100.

Beginning at a block 1202, an event can be received by the client terminal 108 from the interactive casting system 100. Events can include but are not limited to, e-mail alerts, voicemail alerts, incoming phone alerts, news headlines, news tickers, e-commerce opportunities, sports scores, and program reminders. An event may be received via an ATVEF trigger or other information embedded in a television signal, an Internet connection via a DOCSIS channel, a trigger or other information embedded in an out-of-band data stream, and/or other connection, such as a TCP/IP connection via a modem, DSL, or other network connection.

At a block 1204 the processor 220 may detect the event. For example, if the event is contained directly in an ATVEF trigger embedded in a television signal, the processor 220 may read and obtain the event from the trigger. If the ATVEF trigger contains a URL address, the processor 220 may cause the second tuner 210 to receive, via a DOCSIS channel, specific content from a page pointed to by the URL. At a block 1206, the processor 220 checks to see if preferences related to a category of events are stored in user preferences 224. If such preferences do not exist, the process continues on to a block 1210. If, however, user preferences related to a category of events do exist, the next process is at a block 1208, where the processor 220 filters the event received, disregarding the event if the viewer does not wish to have the event displayed as indicia. For example, if the viewer only wants a particular category of events displayed, such as financial news, an event that is a sports headline may be disregarded.

At the block 1210, the processor 220 may process the event to generate indicia. During this step, the processor 220 can take into account user preferences 224 that are related to a format of the indicia. Thus, the event may be formatted into text and/or graphics and preferences as to whether the data is to be displayed as scrolling and/or static indicia may also be considered. A sequence of indicia related to different categories of events and/or functional operations may also be implemented. An example (as discussed in relation to FIG. 9) may include sports indicia followed by e-mail alerts. Another example may include a news ticker that periodically “flips” back to display the time. Sound may also be added at this block. If the data to be displayed is related to content from a web page, the web page may be accessed and parsed by the processor 220 and software to obtain the data to be displayed, in an embodiment.

Next, at a block 1214, instructions for displaying the indicia can be sent to the display driver 209. The display driver 209 may enable communication between the processor 220 and the display device 208. If, for example, the display device 208 is an LCD, the display driver 209 can receive data related to the appearance of indicia and then communicate the data to the display device 208 to control the illumination of necessary pixels. At a box 1216, indicia may be displayed on the display device 208 (e.g., the display 304) for the viewer. The process then begins again at the block 1202, where another event can be received.

In conclusion, an embodiment of the invention can provide a display 304 for a client terminal 108 that can present indicia related to a dynamically received event available through the client terminal. Events can include information related to any subject, such as, but not limited to, news headlines, information related to entertainment and finance, program announcements, reminders, emergency alerts, transaction opportunities related to television broadcasts, and message alerts (e-mail, voicemail, and the like). The display 304 can also show channel settings, time, operational displays, and other functional operations. Additionally, indicia can include moving and/or static text or graphics, as well as sound. Use of the display 304 allows less interference with television images, and makes beneficial use of what would otherwise have been an unused display or redundant basic information.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For instance, a satellite television (TV) delivery system may be implemented alternatively or in addition to a cable distribution system. A satellite TV delivery system may comprise a direct broadcast satellite (DBS) system. A DBS system may comprise a small 18-inch satellite dish (which is an antenna for receiving a satellite broadcast signal); a digital integrated receiver/decoder (IRD), which separates each channel, and decompresses and translates the digital signal so a television can show it; and a remote control. Programming for a DBS system may be distributed, for example, by multiple high-power satellites in geosynchronous orbit, each with multiple transponders. Compression (e.g., MPEG) is used to increase the amount of programming that can be transmitted in the available bandwidth.

A digital broadcast center (e.g., analogous to the head-end 106) may be used to gather programming content, ensure its digital quality, and transmit the signal up to the satellites. Programming may come to the broadcast center from content providers (TBS™, HBO™, CNN™, ESPN™, etc.) via satellite, fiber optic cable, and/or special digital tape. Satellite-delivered programming is typically immediately digitized, encrypted and uplinked to the orbiting satellites. The satellites retransmit the signal back down to every earth-station—or, in other words, every compatible DBS system receiver dish at customers' homes and businesses.

Some programs may be recorded on digital videotape in the broadcast center to be broadcast later. Before any recorded programs are viewed by customers, technicians may use post-production equipment to view and analyze each tape to ensure audio and video quality. Tapes may then be loaded into a robotic tape handling system, and playback may be triggered by a computerized signal sent from a broadcast automation system. Back-up videotape playback equipment may ensure uninterrupted transmission at all times.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A display for a client terminal for a television for an interactive video casting system, the display comprising:
a display screen; and
a display driver coupled to the display screen, the display driver capable to cause the display screen to display screen indicia indicative of events available via the interactive video casting system through the client terminal, the screen indicia capable of being displayed on the display screen at least alternatively to being displayed on the television.

2. The display of claim 1 wherein the screen indicia includes indicia indicative of events available other than through the client terminal.

3. The display of claim 2 wherein the events include at least one of a voicemail alert, incoming phone call alert, and message system alert.

4. The display of claim 1 wherein the screen indicia is capable of being simultaneously displayed on the television and on the display screen.

5. The display of claim 1 wherein the events include at least one of reminders, news headlines, e-commerce opportunities, sports scores, program reminders, program information, television program reminders, e-mail alerts, instant messages and emergency alerts.

6. The display of claim 1 wherein the screen indicia comprises static text.

7. The display of claim 1 wherein the screen indicia comprises dynamic text.

8. The display of claim 1 wherein the screen indicia comprises a combination of dynamic and static text.

9. The display of claim 1 wherein the screen indicia comprises at least one graphical image.

10. The display of claim 9 wherein the screen indicia comprises a combination of text and at least one graphical image

11. The display of claim 1 wherein the display screen is at least one of a liquid crystal display, thin-film transistor (TFT) liquid crystal display, light emitting diode display, backlit display, seven-segment display, four-digit display, and gas plasma display.

12. The display of claim 1 wherein the display screen is capable to be detached from the client terminal.

13. The display of claim 1 wherein the display screen is capable to present a plurality of indicia.

14. In an interactive video casting network, a method comprising:
dynamically receiving data related to an event available via a client terminal for a television;
processing the received data to generate indicia indicative of the event; and
presenting the generated indicia as a screen element via a display screen for the client terminal at least alternatively to presenting the generated indicia on a screen of the television.

15. The method of claim 14 wherein the display screen covers substantially an entire front of the client terminal.

16. The method of claim 14 wherein the display screen includes soft buttons.

17. The method of claim 14 wherein processing the received data includes generating indicia consistent with user preferences.

18. The method of claim 17 wherein the user preferences include preferences related to a format of the generated indicia.

19. The method of claim 17 wherein the user preferences include preferences related to a category of event related to the generated indicia.

20. The method of claim 14 wherein an event comprises at least one of reminders, news headlines, e-commerce opportunities, sports scores, program reminders, record reminders, e-mail alerts, instant messages, and emergency alerts.

21. The method of claim 14, further comprising presenting indicia related to an operational feature of the client terminal.

22. The method of claim 21 wherein the operational feature of the client terminal includes at least one of channel number, time, video cassette recorder (VCR) setting, digital video disk (DVD) setting, menu information, and program information.

23. The method of claim 21 wherein presenting the generated indicia includes presenting indicia of an event sequentially with indicia of the operational feature of the client terminal.

24. The method of claim 14 wherein the received data is sent along with a trigger that accompanies a broadcast television signal received by the client terminal.

25. The method of claim 14, further comprising presenting the generated indicia as sound.

26. The method of claim 25 wherein the generated indicia includes an emergency alert tone.

27. An apparatus, comprising:
a client terminal for a television for an interactive video casting network; and
a display area coupled to the client terminal capable to present screen indicia of events dynamically received from a data source in the interactive video casting network, the display area of the client terminal capable to present the screen indicia at least alternatively to presentation on a screen of the television.

28. The apparatus of claim 27 wherein the data source comprises an Internet.

29. The client terminal of claim 27, further comprising an audible indicator to indicate a received event.

30. The apparatus of claim 27, further comprising a storage medium coupled to the client terminal, the storage medium capable to store data related to a customization of the screen indicia.

31. The apparatus of claim 30 wherein the data related to the customization of the screen indicia includes data related to a sequence and content of the screen indicia.

32. The apparatus of claim 30 wherein the sequence of the screen indicia is related to an order of presentation of screen indicia related to different events.

33. The apparatus of claim 27, further comprising a storage medium capable to store software to process user-preferences related to presentation of the screen indicia.

34. The apparatus of claim 27 wherein the events are capable to be received by at least one of an Ethernet, digital subscriber line (DSL), dial-up modem, telephone connection, and wireless network.

35. The apparatus of claim 27 wherein the dynamically received events include closed captions.

36. A system, comprising:
for an interactive video casting system, a client terminal for a television;
a display screen capable to be coupled to the client terminal; and
a display driver coupled to the display screen, wherein the display screen is capable to present indicia of events available through the client terminal at least alternatively to presentation on a screen of the television.

37. The system of claim 36 wherein the display screen is further capable to present indicia of operational features related to the client terminal.

38. The system of claim 37 wherein the display screen is capable to display indicia of the operational features alternately with indicia of the events.

39. In an interactive video casting system, a method comprising:
receiving a trigger in conjunction with a broadcast content signal;
obtaining an event represented by the trigger;
generating screen indicia of the obtained event; and
displaying the generated screen indicia on a display for a client terminal for a television, wherein the screen indicia is capable of being displayed at least alternatively to being displayed on the television.

40. The method of claim 39 wherein the trigger comprises a television trigger inserted into the broadcast content signal.

41. The method of claim 39 wherein obtaining the event represented by the trigger includes extracting information from a web page.

42. An apparatus, comprising:
a client terminal for a television for an interactive video casting system,
wherein the television includes a screen to display information available from the interactive video casting system,
wherein the television is coupled to the client terminal,
wherein the client terminal is capable of being communicatively coupled to the interactive video casting system to receive the information available from the interactive video casting system and to cause presentation of at least some of the information on the screen of the television,
wherein the interactive video casting system includes a plurality of content sources communicatively coupled to a plurality of broadcast centers,
wherein the broadcast centers are coupled to storage units to store at least some of the information to be made available to the client terminal, and
wherein the interactive video casting system is capable to provide the information to the client terminal via different communication channels, including at least one of a plurality of television broadcast channels and a communication channel with a communication network; and
a display area coupled to the client terminal,
wherein the display area is capable to present screen indicia of events dynamically received from the interactive video casting system, and
wherein the display area of the client terminal is capable to present the screen indicia at least alternatively to presentation on the screen of the television.

43. The apparatus of claim 42 wherein the display area is detachable from the client terminal.

44. The apparatus of claim 42 wherein the client terminal is capable to present an audible indicator representative of a received event.

45. An apparatus, comprising:
a client terminal for a television for an interactive video casting system,
wherein the television includes a screen to display information available from the interactive video casting system,
wherein the television is coupled to the client terminal,
wherein the client terminal is capable of being communicatively coupled to the interactive video casting system to receive the information available from the interactive video casting system and to cause presentation of at least some of the information on the screen of the television,
wherein the interactive video casting system includes a plurality of content sources communicatively coupled to a plurality of broadcast centers,
wherein the broadcast centers are coupled to storage units to store at least some of the information to be made available to the client terminal, and
wherein the interactive video casting system is capable to provide the information to the client terminal via different communication channels, including at least one of a plurality of television broadcast channels and a communication channel with a communication network; and
a display area coupled to the client terminal,
wherein the display area is capable to present screen indicia of events dynamically received from the interactive video casting system,
wherein the display area is capable to display the screen indicia based on user preferences, and
wherein the display area of the client terminal is capable to present the screen indicia at least alternatively to presentation on the screen of the television.

46. The apparatus of claim 45 wherein the display area is capable of being detached from the client terminal.

47. The apparatus of claim 45 wherein the broadcast centers comprise part of a satellite delivery system.

48. In an interactive video casting network, a system comprising:
a means for dynamically receiving data related to an event available via a client terminal for a television;
a means for processing the received data to generate indicia indicative of the event; and
a means for presenting the generated indicia as a screen element via a display screen for the client terminal at least alternatively to presenting the generated indicia on a screen of the television.

49. The system of claim 48 wherein the means for processing the received data includes a means for generating indicia consistent with user preferences.

50. The system of claim 48 wherein the received data is sent along with a trigger that accompanies a broadcast television signal received by the client terminal.
